(19) United States
(12) Patent Application Publication
(10) Pub. No.: US 2026/0365445 A1
(43) Pub. Date: Nov. 19, 2026

(54) ACTIVE CONTROL OF ORDER FULFILLMENT

(71) Applicant: Dematic Corp., Grand Rapids, MI (US)

(72) Inventor: Jared Hills, Lowell, MI (US)

(21) Appl. No.: 19/681,396

(22) Filed: May 19, 2026

Related U.S. Application Data
(60) Provisional application No. 63/808,133, filed on May 19, 2025.

(51) Int. Cl. B65G 43/10; B65G 43/02

(52) U.S. Cl. CPC B65G 43/10; B65G 43/02

(57) ABSTRACT

A control system for controlling the operation of a distribution environment in an exemplary facility including a controller, a sensor, and a conveyance system. The conveyance system includes a sorter, a conveyor, and a storage. A plurality of zones is arranged around the conveyance system. An inner zone is adjacent to the conveyance system. An outer zone is adjacent to the inner zone and surrounds the inner zone, such that the outer zone must be passed through to reach the inner zone. The controller receives sensor data from the sensor, which monitors the inner zone and the outer zone to detect the presence and movements of agents within the inner zone and the outer zone. The controller selects an operational mode for the conveyance system based upon the sensor data received from the sensor.

### CROSS REFERENCE TO RELATED APPLICATION

The present application claims the priority benefit of U.S. provisional patent application ser. no. 63/808,133, filed on May 19, 2025, which is incorporated herein by reference in its entirety.

### FIELD OF THE INVENTION

The present invention is directed to the management of an order fulfillment facility, and in particular to systems and methods for active control of order fulfillment activities.

### BACKGROUND OF THE INVENTION

Warehouse systems, fulfillment centers, e-commerce, and/or manufacturing facilities may each include various distribution environments adapted for particular purposes. Such distribution environments include conveying systems (e.g., sortation systems, conveyors, and/or other suitable conveying means) that are coupled to inventory storage systems (e.g., an automated storage and retrieval system) and processing systems (e.g., order fulfillment areas, manufacturing areas, sales areas, and other similar processing areas). Each of the storage, conveying, and processing systems may be accessed by a variety of different agents (e.g., humans, automated guided vehicles (AGVs), autonomous mobile robots (AMRs), and various human-machine devices), each performing different functions and with varying levels of autonomy and/or access authorization.

### SUMMARY OF THE INVENTION

Embodiments of the present invention provide methods and a control system for controlling the operation of a distribution environment to account for the presence of agents that have physically entered the distribution environment. The distribution environment includes conveyor systems (e.g., sortation systems and conveyors) that are connected to, or include, storage systems (e.g., an automated storage and retrieval system (ASRS)). The control system is configured to detect, identify, and track the presence and movements of any agent entering the distribution environment such that the control system will adjust the operations of the distribution environment in response to the agent’s presence in or near the distribution environment. In an aspect of the present embodiment, the control system will allow the distribution environment to operate normally if a detected agent is an authorized agent. If the detected agent is an unauthorized agent, the control system will adjust the operations of the distribution environment in response to the agent’s movements in and around the distribution environment. If an unauthorized agent is detected, the control system will alter operation speeds and activities of associated conveyance systems within the distribution environment. In an aspect of the present embodiment, the control system can slow operation speed and activities within the storage systems and/or processing systems. Alternatively, the control system can alter the operational speed by, for example, temporarily increasing the operational speed to move articles or materials out of the way and then decreasing the operational speed in selected areas of the distribution environment closest to the unauthorized agent. The operation speeds and activities taking place within the distribution environment (and optionally the storage systems and processing systems) are altered to prevent harm to the unauthorized agent, as well as preventing damage to articles or materials and/or the systems (e.g., conveyors or storage systems within the distribution environment. Based upon the location and/or movement of the unauthorized agent, the control system may further slow or even stop one or more activities within the distribution environment. In a further aspect of the present embodiment, the control system is also configured to monitor the movements of an authorized agent and may adjust the operations of the distribution environment based upon the authorized agent’s movements in and around the distribution environment.

In one embodiment, the distribution environment comprises a conveyor, with the conveyor comprising one or more zones defining one or more physical areas around all or portions of the conveyor. For example, in a particular embodiment a single zone may be disposed about the conveyor. Alternatively, a plurality of zones may be disposed about the conveyor. In an arrangement comprising a plurality of zones, such zones may comprise an outer zone and an inner zone, with the inner zone between the outer zone and the conveyor, and with the inner zone adjacent to the conveyor. In an aspect of the present embodiment, if an agent is detected moving outside of the plurality of zones, the control system will allow the conveyor to operate normally. If the control system detects the agent entering the outer zone, and the agent is monitored as moving parallel to the conveyor, the control system will allow the conveyor to operate normally. While the agent is in the outer zone, a first quantity of computing resources of the control system is dedicated to monitoring a movement vector of the agent as the agent moves in the outer zone, with the first quantity of computing resources higher than a baseline quantity of computing resources for monitoring agents outside the outer zone. If the control system detects the agent’s movement vector changing to intersect with the conveyor, depending on the velocity of the agent, the control system will begin altering the operation of the conveyor. If the agent enters the inner zone and the agent’s movement vector is still intersecting with the conveyor, depending on certain criteria defined by user authorization levels, the control system will further adjust the operation of the conveyor, and as necessary, stop the conveyor to prevent harm to the agent. The control system is configured to identify the agent as either an authorized agent or an unauthorized agent. The control system is configured to further adjust the operation of the conveyor based upon the identity of the agent.

A control system for controlling the operation of a distribution environment in accordance with an embodiment of the present invention comprises a controller, a sensor system, and a conveyance system. The conveyance system includes a sortation system, a conveyor, and a storage system. One or more zones defining one or more physical areas are disposed around all or portions of the conveyance system. In an arrangement of a plurality of zones, an inner zone and an outer zone are arranged around the conveyance system. The inner zone is adjacent to the conveyance system. The outer zone is adjacent to and surrounds the inner zone, such that the outer zone must be passed through to reach the inner zone. The sensor system includes a sensor arranged with respect to the conveyance system and monitors the inner zone and the outer zone to detect the presence and movements of agents within the inner zone and the outer zone. The controller controls the operation of the conveyance system. The controller receives sensor data from the sensor system. The controller selects an operational mode for the conveyance system based upon the sensor data.

In one aspect of the present invention, the sensor data includes information related to the movement of the agents in the one or more zones, such as in a single zone or in the inner zone and the outer zone. The sensor data also includes agent information related to authorization levels for access to the conveyance system of the distribution environment.

In another aspect of the present invention, the storage system is an automated storage and retrieval system (ASRS).

In yet another aspect of the present invention, the agents include human operators or inspectors, humanoids (e.g., robots configured as human-like in function and/or appearance), automated guided vehicles (AGVs), autonomous mobile robots (AMRs), and other human-machine devices (e.g., human-operated devices, such as a forklift, trolley, or other such device) to carry out one or more activities in and around the conveyance system of the distribution environment. In a further aspect of the present invention, the agent is a robot configured as a collaborative or companion robot (a “cobot”). In yet another aspect of the present invention, the robot is configured with an arrangement of wheels for maneuvering, and a manipulator arm for loading, unloading, and/or picking between a conveyor/shelf and a tote (such a tote may be associated with the robot or separate from the robot).

In another aspect of the present invention, the controller identifies particular agents as either authorized agents or unauthorized agents based upon the received sensor data. The sensor data comprises relevant authorizations for each particular authorized agent.

In a further aspect of the present invention, the controller adjusts an operational mode of the conveyance system based upon the identity of a particular detected agent and the movement of that detected agent within the one or more zones, such as in the inner zone and/or the outer zone. The controller also controls the operational mode of the conveyance system to protect both a detected agent and materials moving within the conveyance system based upon the identity and authorization status of the detected agent as well as the movements of the detected agent within the inner zone and the outer zone.

In an aspect of the present invention, the controller can place the conveyance system into a standby mode when an agent is detected in the inner zone. An increased quantity of computing resources is reserved by the controller for monitoring the agent detected in the inner zone when the conveyance system is placed in the standby mode.

In another aspect of the present invention, the controller can change the operational mode of the conveyance system to alter the operations of the conveyance system when either a detected agent within a zone, such as in a single zone or in the inner zone, is identified as an unauthorized agent, or the detected agent has a movement vector that intercepts an operating surface of the conveyance system.

A non-transitory computer-readable medium with instructions stored thereon, that, when executed on a processor, perform the steps for controlling the operation of a distribution environment in a facility in accordance with an embodiment of the present invention. The facility comprises a conveyance system that comprises a sortation system, a conveyor, and a storage system, and a sensor system comprising a sensor arranged with respect to the conveyance system. The steps include arranging one or more zones around the conveyance system, such as either a single zone or an inner zone and an outer zone around the conveyance system. The inner zone is adjacent to the conveyance system. The outer zone is adjacent to and surrounds the inner zone, such that the outer zone must be passed through to reach the inner zone. The steps further include monitoring, with the sensor system, the inner zone and the outer zone to detect the presence and movements of agents within the inner zone and the outer zone. Lastly, the steps include controlling the operation of the conveyance system based on sensor data from the sensor system; and selecting an operational mode for the conveyance system based upon the sensor data.

In accordance with further aspects of the present disclosure, an operational system may be carried by an agent moving in the environment of a facility. In a particular embodiment, for example, an operational system configured to control the operation of a distribution environment of a facility comprises a portable control system configured to be worn by a human and comprising a sensor system comprising a sensor configured to monitor an area around the portable control system to detect robotic agents within the distribution environment, and a control system configured to monitor and track the presence and movement of detected robotic agents with respect to the portable control system. The control system is configured to select an operational mode for a first robotic agent of the detected robotic agents based upon a distance between the portable control system and the first robotic agent.

The first robotic agent comprises one or more zones arranged about the robotic agent and may comprise a single zone or a plurality of zones, such as an inner zone and an outer zone arranged around the first robotic agent. The inner zone is adjacent to the first robotic agent. The outer zone is adjacent to and surrounds the inner zone, such that the outer zone must be passed through to reach the inner zone.

The control system is configured to trigger an operational change of the first robotic agent when a distance between the portable control system and the first robotic agent is below a minimum distance threshold.

The minimum distance threshold is defined by a distance between the portable control system and an outer edge of a zone, such as the outer edge of a single zone or the outer zone of the first robotic agent, such that when the distance between the portable control system and the first robotic agent is below the minimum distance threshold, the portable control system is physically within the single zone or outer zone.

The portable control system is configured to trigger a first operational change of the first robotic agent when the portable control system determines that the portable control system has entered the single zone or, in the case of a plurality of zones, the outer zone of the first robotic agent as defined by the distance between the portable control system and the first robotic agent. The portable control system is configured to trigger a second operational change of the first robotic agent when the portable control system determines that the portable control system has entered the inner zone of the first robotic agent as defined by the distance between the portable control system and the first robotic agent.

The portable control system is configured to trigger a first operational change of the first robotic agent when the portable control system determines that the portable control system has entered the single zone or, in the case of a plurality of zones, the outer zone of the first robotic agent. The portable control system is configured to trigger a second operational change of the first robotic agent when the portable control system determines that the portable control system has entered the inner zone of the first robotic agent.

The operational change of the first robotic agent comprises at least one of a slower speed and a path adjustment for the first robotic agent such that a collision or accident between the portable control system and the first robotic agent is avoided.

The operational system further comprising a control system configured to communicate with the portable control system, such that the control system is configured to further control the distribution environment of the facility.

In another aspect of the present invention, a method is disclosed for controlling the operation of a distribution environment of a facility by way of a portable control system carried by an agent. In an embodiment the method comprises providing a portable control system to be worn by a human, where the portable control system comprises a sensor and a controller or control system, monitoring, with the sensor, an area around the portable control system to detect robotic agents within the distribution environment, monitoring and tracking, with the controller or control system, the presence and movement of detected robotic agents with respect to the portable control system, and selecting, with the controller or control system, an operational mode for a first robotic agent of the detected robotic agents based upon a distance between the portable control system and the first robotic agent.

The method further includes triggering, with the controller or control system, an operational change of the first robotic agent when a distance between the portable control system and the first robotic agent is below a minimum distance threshold.

The first robotic agent comprises one or more zones, such as a single zone or a plurality of zones. In an embodiment of a plurality of zones, an inner zone and an outer zone are arranged around the first robotic agent. The inner zone is adjacent to the first robotic agent. The outer zone is adjacent to and surrounds the inner zone, such that the outer zone must be passed through to reach the inner zone.

The minimum distance threshold is defined by a distance between the portable control system and an outer edge of the single zone or, in an embodiment having a plurality of zones, the outer zone of the first robotic agent, such that when the distance between the portable control system and the first robotic agent is below the minimum distance threshold, the portable control system is physically within the outer zone.

The method further comprising triggering, with the portable control system, a first operational change of the first robotic agent when the portable control system determines that the portable control system has entered a zone of the robotic agent, such as the single zone or, in the case of a plurality of zones, the outer zone of the first robotic agent as defined by the distance between the portable control system and the first robotic agent, and triggering, with the portable control system. A second operational change of the first robotic agent may occur when the portable control system determines that the portable control system has entered the inner zone of the first robotic agent as defined by the distance between the portable control system and the first robotic agent.

The method further comprising triggering, with the portable control system, a first operational change of the first robotic agent when the portable control system determines that the portable control system has entered a zone disposed about the first robotic agent, such as a single zone or the outer zone of an embodiment with multiple zones, and triggering, with the portable control system. And a second operational change of the first robotic agent may occur when the portable control system determines that the portable control system has entered the inner zone of the first robotic agent in the case of an arrangement having an inner and outer zone.

The operational change of the first robotic agent comprises at least one of a slower speed and a path adjustment for the first robotic agent such that a collision or accident between the portable control system and the first robotic agent is avoided.

The method further comprising providing a control system configured to communicate with the portable control system, such that the control system is configured to further control the distribution environment of the facility.

These and other objects, advantages, purposes and features of the present invention will become apparent upon review of the following specification in conjunction with the drawings.

### BRIEF DESCRIPTION OF THE DRAWINGS

FIG. 1 is a perspective view of an exemplary distribution environment of a fulfillment system in accordance with aspects of the present invention;

FIG. 2A is a top-down view of the distribution environment of FIG. 1;

FIG. 2B is another top-down view of the distribution environment of FIG. 1 with an alternative configuration in accordance with the present disclosure;

FIG. 2C is a perspective view of an exemplary material-handling robotic unit in accordance with aspects of the present invention;

FIGS. 3A - 3D are top-down views of an exemplary method for controlling operations carried out within a fulfillment system based upon the movements of agents detected and tracked in an environment associated with the fulfillment system in accordance with the present invention;

FIGS. 4A - 4G are top-down views of an exemplary method for controlling operations carried out within a fulfillment system based upon particular shapes or contours of an agent detected and tracked in an environment associated with the fulfillment system in accordance with the present invention;

FIGS. 5A - 5E are views of an exemplary method for controlling operations carried out within a fulfillment system based upon movement vectors and shapes/contours of an agent detected and tracked in an environment associated with the fulfillment system in accordance with the present invention;

FIG. 6 is a block diagram illustrating an exemplary active control and safety system for an order fulfillment system for an exemplary distribution environment in accordance with the present invention; and

FIG. 7 is a block diagram illustrating a plurality of the active control and safety systems of FIG. 6, each coupled to a respective portion of the order fulfillment system in accordance with the present invention.

### DESCRIPTION OF THE PREFERRED EMBODIMENTS

Referring to the drawings and the illustrative embodiments depicted therein, wherein numbered elements in the following written description correspond to like-numbered elements in the figures, an active control and safety system for a distribution environment of a fulfillment system utilizes sensors for detecting and monitoring the actions of agents (e.g., humans, robots, human-machine devices, and the like) that are detected entering the distribution environment to control the operations carried out within the distribution environment to ensure safety and security with respect to agents entering and moving within the distribution environment. Such agents, without limitation, are understood to be capable of carrying out one or more activities in and around the distribution environment of the fulfillment system (e.g., in and around a conveyance system or other areas within the fulfillment system).

An exemplary controller of an active control and safety system controls the operations of a distribution environment of a fulfillment system to account for the presence of agents (e.g., humans, robots, human-machine devices, and the like) that have physically entered the distribution environment. The active control and safety system includes sensors that detect, identify, and track the presence and actions of any agent entering and moving within the distribution environment, such that the controller will adapt the operations of the distribution environment in response to the detection and/or motions/actions of an agent. The controller will allow the distribution environment to operate normally if a detected agent is identified as an authorized agent. If the detected agent is identified as an unauthorized agent, the controller will adjust the operations of the distribution environment. Based upon the identity of the agent and the movement of the agent within the distribution environment, the controller system is configured to alter operation speeds and activities of associated conveyance systems, storage systems, and processing systems within the distribution environment. The operation speeds and activities taking place within the distribution environment are altered to prevent harm to the agent (e.g., an unauthorized agent), as well as preventing damage to the conveyors or storage systems that are moving articles or materials through the distribution environment (as well as preventing damage to those articles or materials as well). The controller is also able to further slow or even stop one or more activities taking place within the distribution environment based upon a location and/or movement of the agent. Alternatively, the controller may temporarily increase the operational speeds of systems within the distribution environment to move articles or materials out of the way and then decrease the operational speeds for selected regions of the distribution environment based upon the location of the agent. Optionally, the controller may trigger a notification or alert message after detecting anomalous events/activities and transmit the notification or message to other authorized agents.

In one embodiment, the conveyance system of the distribution environment comprises a conveyor, with the conveyor comprising one or more safety zones defining physical areas around all or portions of the conveyor. A single zone may be employed or a plurality of safety zones may be employed. In the case of a plurality of zones the zones may define different physical areas around the conveyor. In the arrangement of a plurality of zones, such zones may include an outer zone and an inner zone, with the inner zone between the outer zone and the conveyor, and with the inner zone adjacent to the conveyor. If an agent is determined to be moving outside of the one or more zones, the controller of the active control and safety system will allow the conveyor to operate normally. In the case of inner and outer zones, if the agent is determined to have entered the outer zone and is moving parallel to the conveyor, the controller will allow the conveyor to operate normally. While the agent is in the outer zone, a first quantity of computing resources available to the controller will be dedicated to monitoring a movement vector of the agent as it moves in the outer zone. The first quantity of computing resources is a higher quantity of computing resources than a baseline quantity of computing resources for monitoring agents outside the outer zone. If the movement vector of the agent changes to intersect with the conveyor, depending on the velocity of the agent, the controller will begin altering the operation of the conveyor. If the agent enters the inner zone and the agent’s movement vector is still intersecting with the conveyor, as defined by the agent’s identification (e.g., an authorized agent or unauthorized agent), the controller will further adjust the operation of the conveyor. For example, when necessary to prevent harm to the agent, the controller can stop the conveyor.

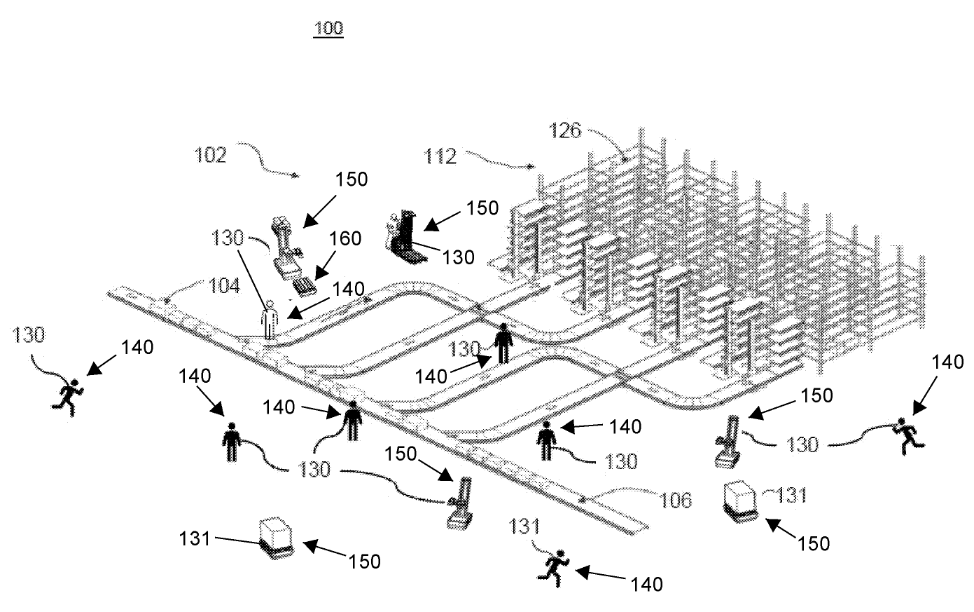

FIG. 1 illustrates an exemplary distribution environment 100 suitable for a site such as warehouse, fulfillment center, e-commerce, manufacturing, and so forth in accordance with one or more implementations. The distribution environment 100 of FIG. 1 includes a conveyance system, such as, a sortation system 102, a conveyor 106, and other suitable conveying systems. The distribution environment 100 also includes an automated storage and retrieval system (ASRS) 112 coupled to the conveying system (i.e., the sortation system 102 and the conveyor 106) directly or indirectly. An exemplary sortation system 102 may be as described in commonly assigned U.S. Patent No 7,086,519, issued Aug. 8, 2006, which is hereby incorporated herein by reference in its entirety. An exemplary sortation system 102 may be configured as an extensive system of conveyors, etc., or may use AMRs, or the like. In one embodiment, the exemplary sortation system 102 may include cross-belt sorters, sorting mezzanines, and Bombay-style sorters. An exemplary ASRS may be as described in commonly assigned U.S. Patent Nos. 8,974,168, issued Mar. 10, 2015, 9,266,675, issued Feb. 23, 2016, and/or 9,630,777, issued Apr. 25, 2017, which are each hereby incorporated herein by reference in their entireties. An exemplary AMR or AGV may be as described in commonly assigned U.S. Patent Publication Nos. 2024/0174445, published on May 30, 2024, and Publication No. 2022/0309447A1, published Sep. 29, 2022, both of which are hereby incorporated herein by reference in their entireties.

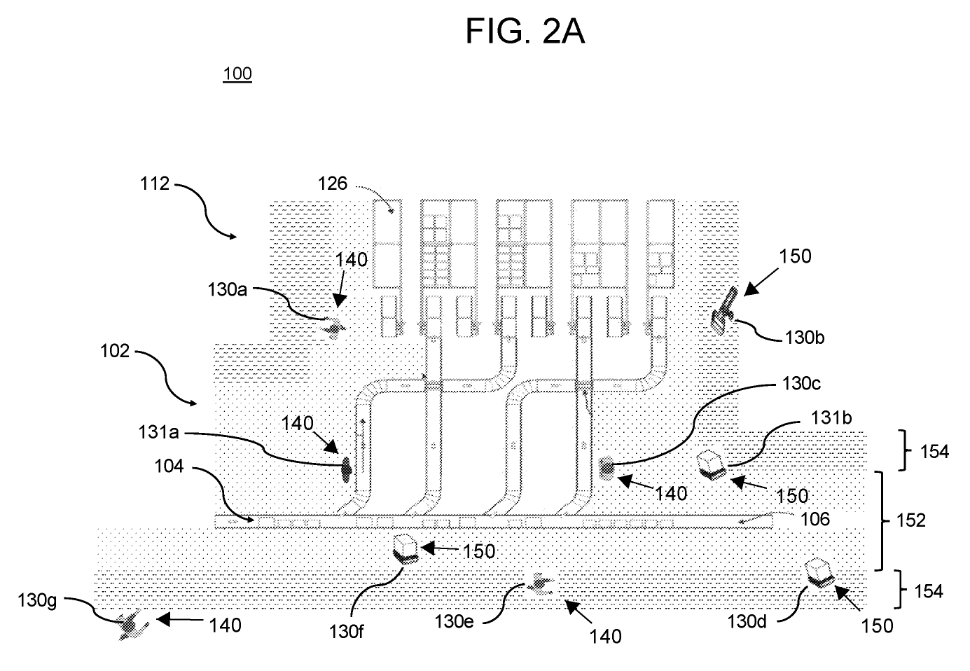

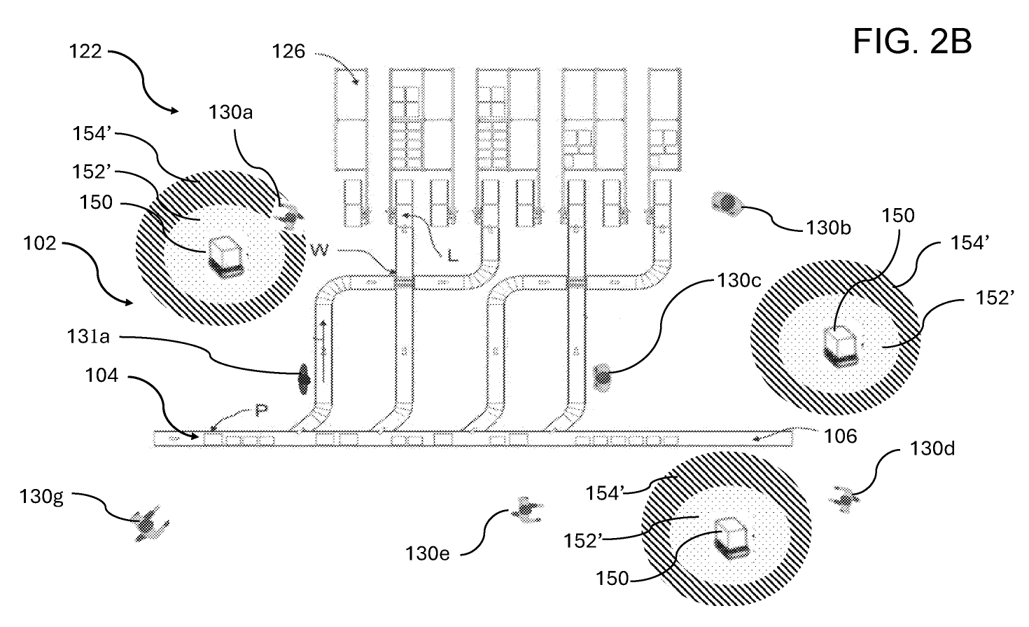

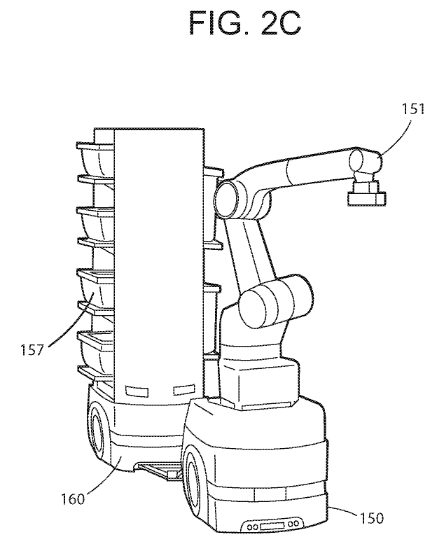

A variety of different authorized agents 130, such as, humans 140, e.g., human operators, workers, inspectors, and the like, robots 150, e.g., automated guided vehicles (AGVs), autonomous mobile robots (AMRs), collaborative or companion robots (“cobots”), humanoids (robots with human-like appearance and/or features), and the like, and other human-machine devices, such as forklifts and the like, are employed to carry out one or more activities within the distribution environment of the fulfillment system. As illustrated in FIGS. 1 and 2A-2C, exemplary robots 150 may be implemented in a variety of different configurations for different tasks. In one embodiment, a robot 150 may be configured as a humanoid (a robot with a human-like shape/features). In another embodiment, a robot 150 may be configured with a robotic arm 151 capable of picking articles for transfer to/from an associated tote or totes 157, where the totes 157 may, for example, be associated with a bin assembly 160 (see FIGS. 1 and 2B). With continued reference to FIGS. 1 and 2B, it is understood that the robot 150 and the bin assembly 160 may be implemented in a variety of different configurations. For example, a tote 157 or bin assembly 160 may be directly integrated with a robot 150 or the tote or bin assembly 160 may be a separate assembly from the robot 150. In one embodiment, the tote 157 and/or bin assembly 160 may be integrated with a robot (e.g., an AGV or AMR), such that a separate robot 150 with a robotic arm interacts with the bin assembly 160. Alternatively, the tote 157 or bin assembly 160 is mounted on wheels to be towed by another device or a human. An exemplary robot 150 may be configured as described in commonly assigned U.S. Patent No. 9,550,624, issued Jan. 24, 2017. As discussed herein, and illustrated in FIGS. 1-7, while individual agents 130 may be human 140 or a humanoid robot 150, or may be configured as an alternatively configured robot 150 such as AGVs and AMRs, it is understood that such agents 130 may be any of a variety of different configurations or entities (e.g., humans 140, robots 150, and/or human-machine devices without limitation).

These agents 130 are allocated and/or assigned to one or more order channels within the distribution environment 100. While agents 130 with “full authorization” may be seen on-site, other agents (e.g., agent 131) with “limited authorization” may also be seen on site to perform limited activities. For example, these agents with limited authorization (e.g., an unauthorized agent 131) may include visitors, guests, non-distribution employees, and so forth. In one aspect of the present embodiment, certain employees working within the distribution environment 100 and with limited authorization may be assigned to certain areas within the distribution environment 100 to perform tasks within those certain areas while limiting their travel to restricted areas or other areas within the distribution environment 100 where those employees (i.e., unauthorized agents 131) are not permitted. In another aspect of the present embodiment, while in general, robots 150 may be considered to be authorized agents 130 (e.g., agents 130b, 130d, and 130f in FIG. 2A), certain other robots 150 may be considered to be limited or unauthorized agents 131 (e.g., agent 131b), e.g., robots 150 that are working within or passing through a facility on a limited or restricted basis. It is understood that while certain agents 130, 131 have been depicted in FIGS. 1-5 as humans 140 or robots 150, the agents 130, 131 may be, without limitation, any of the types of agents 130, 131 discussed herein (e.g., humans 140, robots 150, and other human-machine devices).

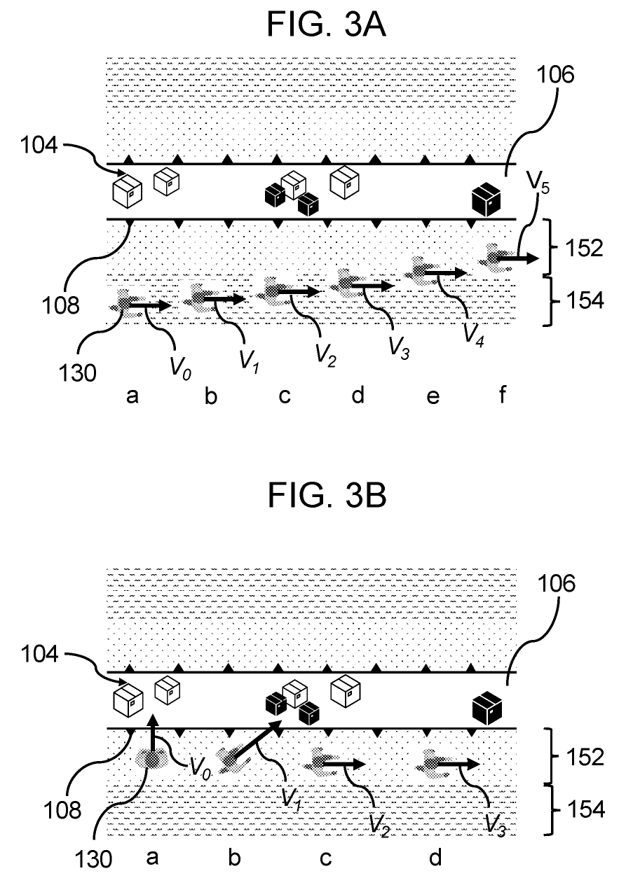

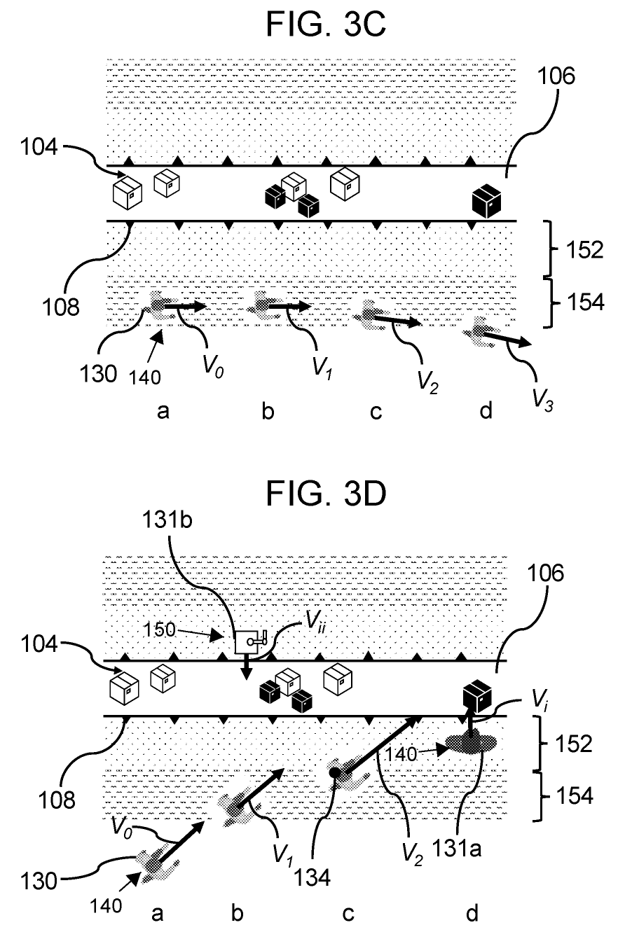

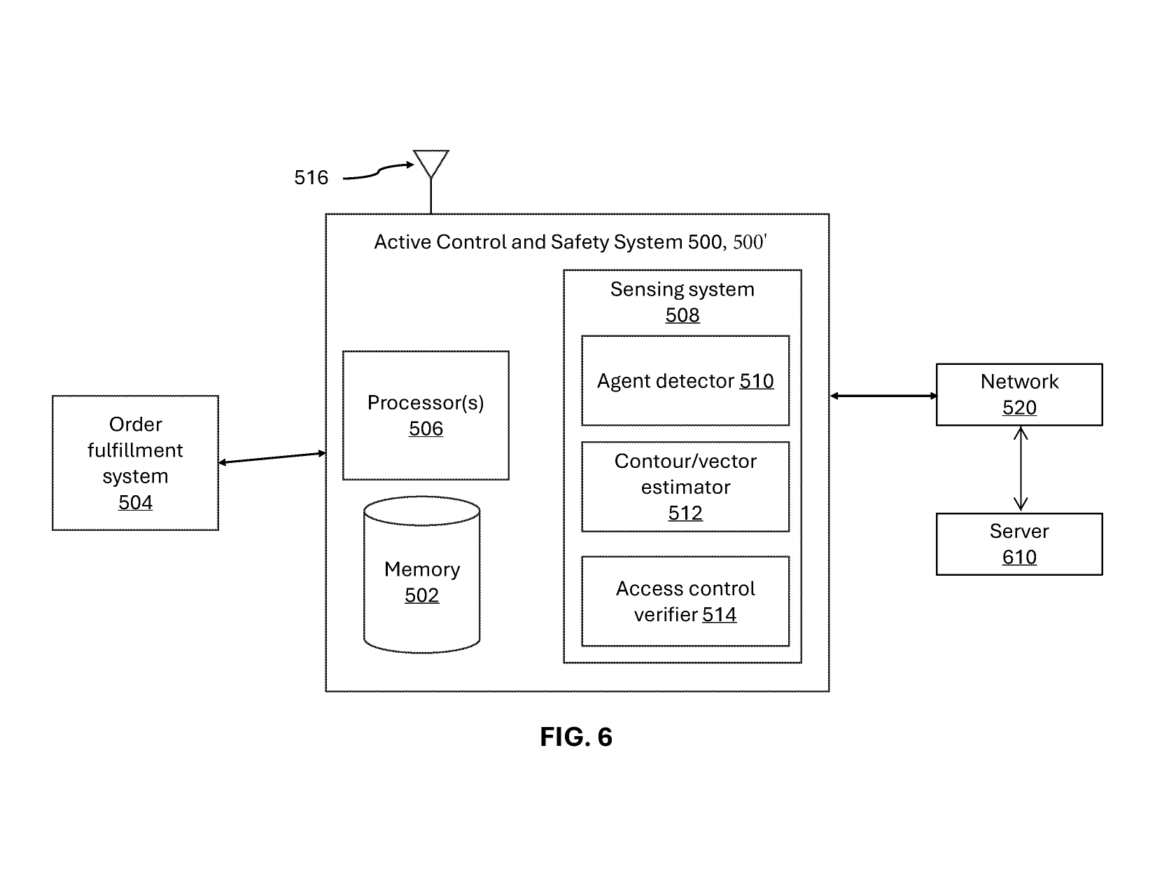

FIG. 2A illustrates a top-down view of the distribution environment 100 of FIG. 1 in accordance with one or more embodiments of the disclosure. The floor includes sections defined as an inner zone 152 and an outer zone 154. The floor may be located on a ground level, a higher or upper level, a lower level, or a basement. The inner zone 152, proximal to certain sections of the system, such as, an ASRS 112, a sortation system 102, and a conveyor 106, defines a restricted area within the distribution environment 100. The outer zone 154, which is outside the inner zone 152 and away from the sortation system 102, the conveyor 106, and the ASRS 112, but proximal to the inner zone 152, defines a less restricted area of the distribution environment 100. The distribution environment 100 includes authorized agents 130a-130g and unauthorized or limited authorization agents 131a and 131b that can travel between the inner and outer zones 152, 154. As illustrated in FIGS. 1 and 2A, the authorized agents 130a-130g and unauthorized or limited authorization agents 131a and 131b may be any type of agent discussed herein, such as humans 140, robots 150, and/or human-machine devices or other combinations thereof. Agents 130a-130g with full authorization may travel freely in both inner and outer zones 152, 154. Agents 131a, 131b with partial or limited authorization may travel freely in the outer zone 154, but only travel to specific regions within the inner zone 152. In another embodiment, the unauthorized agents 131 can only travel in the outer zones 154. As illustrated in FIGS. 3A-3D and 6, an exemplary sensing system 508, comprising sensors (e.g., sensor 108), is used to detect and monitor the actions of agents 130, 131 as they move into and out of the inner and outer zones 152, 154. As depicted, agent 130g located on the outer zone 154 is traveling toward the conveyor 106, while agents 130b, 130d, and 130e are located either inside or along the outer zone 154 and are traveling either toward or away from one of the systems (the sortation system 102, the conveyor 106, and the ASRS 112). Agent 130a, on the other hand, is located within the inner zone 152 but is traveling toward or entering into the outer zone 154. Unlike the other agents 130a, 130b, 130d-130g, agent 130c is positioned inside the inner zone 152 and facing the sortation system 102. As the agents 130a-130g, 131a, 131b approach or move away from one of the systems (the sortation system 102, the conveyor 106, and the ASRS 112), their individual actions will cause one or more operational changes on the systems 102, 106, 112. The operational changes may include speed adjustments (such as slowing down, temporarily stopping, or accelerating), and/or activating or deactivating the sortation system 102, the conveyor 106, and/or the ASRS 112. Other possible operational changes may be included that ensure the materials moving through the systems 102, 106, 112 are handled appropriately while also minimizing risks (i.e. accidents) during operation. Such speed changes or operational changes are triggered as defined by the authorization level of the agent 130, 131, and other factors related to the individual agent 130, 131, and movement vectors of the agent 130, 131.

FIG. 2B illustrates another top-down view of the distribution environment 100 of FIG. 1 in accordance with one or more embodiments of the disclosures. In addition to the zones 152, 154 defined in FIG. 2A, a second set of zones 152’, 154’ is formed around agents 150. An active control and safety system, similar to the system 500 illustrated in FIG. 6 is configured to detect, identify, monitor, and track the presence and actions of nearby agents 130a, 130c, 130d, 130e as they enter, move within, and/or exit the zones 152’, 154’. Based on the detected motions and/or actions of the nearby agents, 130a, 130c, 130d, 130e, the system 500 adapts the operations of the agents 150 accordingly. As illustrated, the zones 152’, 154’ around the agents 150 are circular in shape, however, other shapes such as elliptical, triangular, square, rectangular, and/or polygonal shapes, may be implemented. As agents 130a, 130c, 130d, 130e approach or move away from the agents 150, such as AMRs, AGVs, forklifts, autonomous palletizer/depalletizer, their individual actions may trigger one or more operational changes in the agents 150. Such operational changes may include speed and/or path adjustments, such as pausing, decelerating, accelerating, rerouting, diverting, reversing, turning, or yielding to approaching agents 130a, 130c, 130d, 130e.

FIGS. 3A-3D illustrate an exemplary process for controlling a conveyance system (e.g., conveyor 106) by either tracking an agent 130 either approaching or leaving the conveyor 106 and at least one or more of an inner zone 152 and an outer zone 154, or by tracking a movement vector of the agent 130 intersecting with the zones 152, 154 and/or the conveyor 106. As illustrated in FIGS. 3A-3D, an exemplary system is depicted as a conveyor 106 for transporting articles or materials 104 from one end to another end (as discussed herein, other systems are also anticipated: a sortation system 102 or an ASRS 112). The zones 152, 154 are partitioned or divided into sections (e.g., sections “a-f”). Referring to FIG. 3A, an agent 130 with a movement vector V0 pointing to the right, is positioned at section “a” and is within outer zone 154. As the agent 130 continues to travel from section “a” to section “d,” and remains within the outer zone 154, movement vectors V1, V2, and V3 continue to point in the same direction as illustrated with respect to movement vector V0. Accordingly, the conveyor 106 is allowed to continue operating at a normal or regular speed. As soon as the agent 130 enters (or begins to enter) the inner zone 152, and the movement vector V4 intersects either the border line formed between the inner zone 152 and outer zone 154, or the inner zone 152 at section “e”, a standby mode is activated to prepare for operational changes on the conveyor 106. With continued reference to FIG. 3A, the agent 130 continues to travel within the inner zone 152 and in the direction toward section “f.” Movement Vector V5, which is identical to movement vector V4, continues to keep the conveyor 106 on standby mode and ready for operational changes (because the agent 130 continues to remain in the inner zone 152). It is understood that while the agent 130 depicted in FIGS. 3A-3D is a human 140, the agent 130 (depicted in FIGS. 3A-3D) could also be a robot 150 with any of the configurations discussed herein, or any of the human-machine devices and other combinations thereof, and the like.

As discussed herein, because the agent 130 is also considered to be an authorized agent, the conveyor 106 will continue to operate as normal even within the inner zone 152, so long as an associated movement vector does not indicate that the agent 130 will come into contact with an edge of the conveyor 106. For example, unless movement vector V5 intersects with the conveyor 106 (indicating that the agent 130 will come into physical contact with the conveyor 106, at for example, an edge of the conveyor 106), the conveyor 106 will continue to operate as normal without operational changes. In another embodiment, while movement vector V5 may not intersect the conveyor 106, movement vector V5 is parallel with and in close proximity to the conveyor 106, such as within an arm length between the agent 130 and the conveyor 106. As a result, operational changes may be triggered for the conveyor 106. In other words, in one embodiment, even if the agent is an authorized agent 130, if that authorized agent 130 has moved within a threshold distance from the conveyor 106, the conveyor’s operational mode will be changed (e.g., the conveyor’s speed may be altered (e.g., slowed) and/or additional monitoring resources may be dedicated to tracking the agent 130).

Now with reference to FIG. 3B, an authorized agent 130 at section “a” is depicted facing the conveyor 106 with a movement vector V0 intersecting with an edge of the conveyor 106. The intersection between the authorized agent 130 and the conveyor 106 (at the edge of the conveyor) thereby prompts or triggers an operational change, such as a slower speed, in the conveyor 106. As the authorized agent 130 travels from section “a” to section “b,” its movement vector, while changing from movement vector V0 to movement vector V1, continues to intersect with the conveyor system 106. Thus, the previous operational changes for the conveyor 106 continue, such as a continued slower operational speed. As discussed herein, optionally, the operational speed may be temporarily increased to move certain articles or materials 104 out of a portion of the conveyor 106 (e.g., located near the edge) before slowing the operational speed of the conveyor 106. With continued reference to FIG. 3B, after the authorized agent 130 reaches section “c” and faces away from the conveyor 106 (or at a minimum, that its movement vector (e.g., movement vector V2) is no longer intersecting with the conveyor 106), the conveyor 106 may now receive a new or updated operational change, such as, an accelerated speed, triggered by the movement vector V2, which is not intersecting with the conveyor 106. As the agent 130 continues to travel in the same direction towards section “d,” the conveyor 106 continues to operate at an accelerating speed until the conveyor reaches the normal mode. As can be seen with reference to FIG. 3B, the authorized agent 130 travels within the inner zone 152 from section “a” to section “b” without changing areas from inner zone 152 to outer zone 154 or crossing the border and entering into outer zone 154.

When compared with FIG. 3B, the authorized agent 130 depicted in FIG. 3C is traveling along and within the outer zone 154 and begins from section “a” to section “d” having movement vectors V0-V3 pointing away from the inner zone 152 and/or the conveyor 106. Since none of the movement vectors V0-V3 intersect with either the conveyor 106 or the inner zone 152, the operational change mode (to the conveyor 106) will not be triggered, and the conveyor 106 will continue operating at a normal mode. As discussed herein, depending on whether the authorized agent 130 is physically within the inner zone 152 or the outer zone 154, even if normal mode is maintained, a standby mode may be entered, and an additional quantity of processing resources can be detected to monitoring the agent 130.

Now with reference to FIG. 3D, an authorized agent 130 is traveling along a path from section “a” to section “d” having movement vectors V0-V3 facing towards and intersecting with either the edge of the conveyor 106 (e.g., movement vector V2) or with the inner zone 152 (e.g., movement vector V1), which triggers the operational change mode to reduce the speed gradually until (if the authorized agent 130 continues towards the conveyor 106 requiring further operational changes) the conveyor 106 comes to a temporary pause or stop.

It should be appreciated that although shown as including inner and outer zones 152/152’ and 154/154’, that alternatively a single zone may be employed, such as just an inner zone 152/152’ disposed about the equipment of interest, whereupon detection with respect to such a single zone an operational change may be implemented. It should be appreciated that aspects discussed herein with respect to inner and outer zones may be implemented in an arrangement having a single zone. Still further, although zones 152/154 and 152’/154’ are illustrated in the accompanying figures as not overlapping and having set dimensions about the equipment of interest, it should be appreciated that alternative arrangements of the geometrical configuration of the zones may be employed. For example, zones may be overlapping with varying sizes, such as with respect to diameter or width, are possible and do not deviate from the concepts disclosed herein and would operate as intended within the scope of the present disclosure.

An exemplary method of controlling the operation of a conveyance system (e.g., conveyor 106) is executed by one or more processors or controllers, and/or memory configured to store computer-executable instructions, and with at least one processor configured to access the memory and execute the computer-executable instruction to perform various actions such as controlling the conveyor 106 to slow down, pause temporarily, accelerate, activate, deactivate, and/or resume operations. The processor in communication with a sensing device may either track the authorized agent 130 moving between the inner zone 152 and the outer zone 154, or track an authorized agent 130 whose movement vector is determined to be intersecting with at least one of the zones 152, 154, an edge of the conveyor 106, or both.

With further reference to FIG. 3D, one or more unauthorized agents 131a, 131b (e.g., unauthorized agent 131a is depicted as a human 140, while unauthorized agent 131b is depicted as a robot 150) other than the authorized agent 130 may be present in the distribution environment 100 (e.g., such as near the conveyor 106 depicted in FIG. 3D). As discussed herein, the authorized agent 130 has full authorization to access the entire distribution environment 100, while the unauthorized agents 131a, 131b have partial or limited rights (or authorization) to access only certain portions of the distribution environment 100. A discrepancy is detected via the sensors (e.g., sensor 108) of a sensing system 508 (as shown in FIG. 6) when movement vectors Vi and Vii associated with the unauthorized agents 131a, 131b intersect with the conveyor 106 (e.g., intersecting with an edge of the conveyor 106) which in turn results in operational changes, such as, reducing the speed of the conveyor 106 or stopping the conveyor 106 until the agents 131a, 131b exit the inner zone 152 and/or travel toward or within the outer zone 154 (such that the movement vectors Vi and Vii no longer intersect with the conveyor 106). The conveyor 106 is then safely returned to normal operations and returns to and runs at normal speed. As noted herein, while unauthorized agents 131a, 131b are depicted as a human 140 and a robot 150, respectively, it is understood that the unauthorized agents 131 may be any of the entities discussed herein (e.g., humans 140, robots 150, and/or human-machine devices, or other combinations thereof).

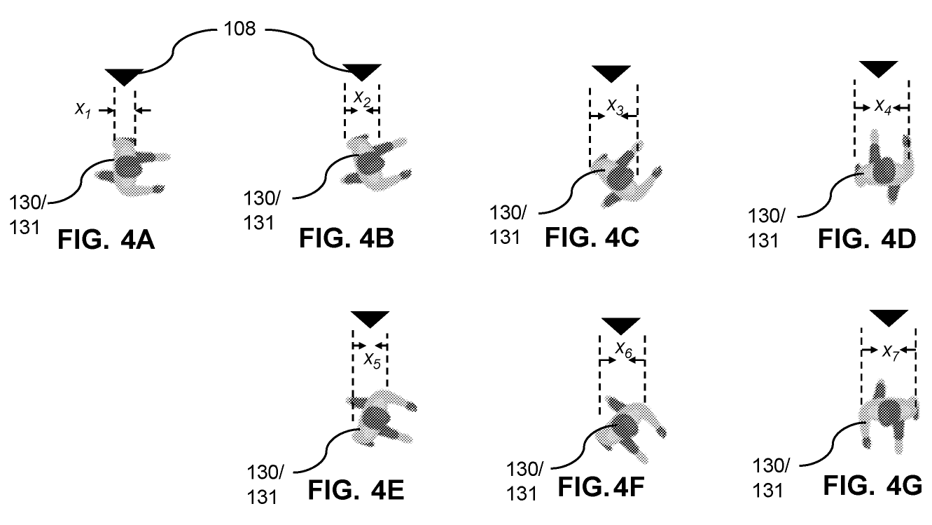

FIGS. 4A-4G illustrate another exemplary process for controlling a conveyance system within the distribution environment 100, such as a sortation system 102, a conveyor 106, or an ASRS 112, by tracking a contour of a particular body shape of the agent 130, 131 or by monitoring or reviewing body shape information associated with the agent 130, 131, while the agent 130, 131 is entering or leaving the zones 152, 154. The body shape information may include, for example, height, weight, and shoulder or width circumference of the agent 130, 131. It is understood that in this embodiment the authorized or unauthorized agent 130, 131 is a human 140. In other embodiments, similar shape or contour information can be used with respect to other types of agents 130, 131 (e.g., robots 150 (e.g., AMRs and/or AGVs), or human-machine devices, and the like). With continuing reference to FIGS. 4A-4G, contours X1-X7 are defined by the shoulder or width circumference using a sensor device such as a depth sensor, a contour estimator, or any type of sensor suitable for detecting a body shape or contour of the body of the agent 130, 131 (e.g., a contour/vector estimator 512 of the sensing system 508 of FIG. 6). As discussed herein, when the agent 130, 131 is a robot 150 or other similar device, the contours X1-X7 may vary (with respect to the particular robot’s configuration) from the contours X1-X7 associated with a human 140. Different operational changes may be triggered by different contours X1-X7 associated with certain movement vectors. For example, the agent 130, 131 in FIG. 4A and having contour X1 travels in an exemplary direction parallel to a conveyance system (e.g., a sortation system 102, a conveyor 106, or an ASRS 112 as illustrated in FIGS. 1 and 2A), while the agent 130, 131, in FIGS. 4D and 4G, with the chest pointing at the conveyance system (e.g., a conveyor 106), the agent 130, 131 has contour X4, and with the back facing the system 102, 106, 112 the agent 130 has contour X7. The contour value of X1 detected by the sensor device (e.g., the contour/vector estimator 512 of FIG. 6) is considered to be the smallest value and therefore will not affect the operational mode of the conveyance system 102, 106, 112 (as the contour X1 indicates the agent 130, 131 is moving parallel to the conveyance system 102, 106, 112, whereas the contour values of X4 and X7, as detected by the sensor device, are said to be the largest values and would therefore trigger operational changes to the conveyance system 102, 106, 112. The contours X2, X3, X5, and X6 of the agent 130, 131 (depicted in FIGS. 4B, 4C, 4E, and 4F) having values ranging between the minimum value of contour X1 and the maximum value of contours X4 or X7, may further trigger different operational changes of the conveyance system 102, 106, 112 depending on the circumstances (e.g., whether the agent 130, 131 is within or approaching the inner zone 152 or within the outer zone 154, and whether the detected agent is an authorized agent 130 or an unauthorized agent 131).

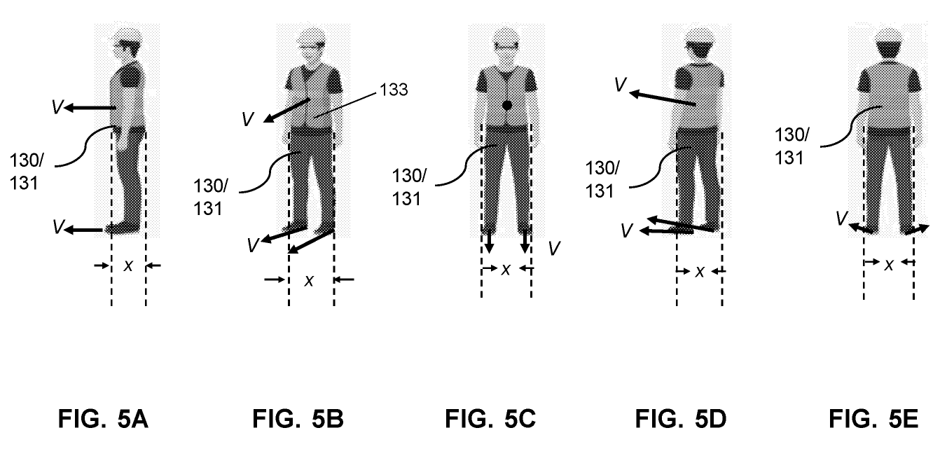

With reference to FIGS. 5A-5E, another exemplary process for controlling at least one or more of a conveyance system (e.g., a sortation system 102, a conveyor 106, or an ASRS 112) and an agent 150 is illustrated where the conveyance system 102, 106, 112 or the agent 150 is controlled by tracking both a vector V and a contour X of an agent 130, 131 in accordance with one or more embodiments. The individual methods for tracking a vector V and a contour X are identical to those methods described herein with respect to FIGS. 3A-3D and 4A-4G, and thus will not be described herein. As noted herein, while the agent 130, 131 depicted in FIGS. 5A-5E is a human 140, in other embodiments other types of agents 130, 131 (with corresponding vectors V and contours X as the agents 130, 131 move about) are anticipated (e.g., robots 150 (e.g., AMRs and AGVs, and the like), or other human-machine devices).

A controller for controlling the conveyance system 102, 106, 112 or the agent 150 includes one or more processors and/or memory configured to store computer-executable instructions, and at least one processor configured to access the memory and execute the computer-executable instruction(s) to perform various actions such as commanding the conveyance system 102, 106, 112 to slow down, pause temporarily, accelerate, activate, deactivate, and/or resume its operation. The processor in communication with a sensing device (e.g., the sensing system 508 of FIG. 6) may either track the agent 130, 131 moving between first zone region 152, 154 and/or second zone region 152’, 154’, track a movement vector V of the agent 130, 131, and whether the movement vector V intersects with one or both of the zone regions 152/154 and/or 152’/154’ and the conveyance system 102, 106, 112 or the agent 150, track a contour X of the agent 130, 131, or a combination thereof. The sensing device (e.g., the sensing system 508) may also detect one or more of certain detectable devices or objects 133 (FIG. 5B) on or carried by the agent 130, 131, such as apparel worn by the agent 130, 131, or other objects, such as, a vest, a wearable device, a badge/pass, a key card/fob or the like. The sensing device (e.g., the sensing system 508) may also detect different colors/prints/patterns on the apparel. The wearable device may be a wearable electronic device such as a watch, eyewear, headwear, smart phone, or any portable device suitable for the application. The badge/pass may be a visitor pass, an employee badge, or the like. The key card/fob may be identical to the badge/pass. In another embodiment, the active control and safety system 500 for detecting, identifying, monitoring, and tracking the presence and actions of nearby agents 150 may be implemented as a portable device (e.g., an active control and safety system 500’) to be carried or worn, such as a vest, by the agent 130, such as a human. As the agent 130 approaches one or more of the robots (e.g., agent 150) and enters the zones 152’/154’ surrounding the agent 150, the control system 500’ (worn or carried by the agent 130 and comprising a controller) triggers or prompts an operational change such as a slower speed and/or path adjustments in the agent 150 directly or indirectly to avoid collision or accident. The system 500’ is also configured to communicate or exchange information between the badge/pass and the portable version of the system (e.g., active control and safety system 500’) worn on the agent 130 via short-range communication protocol such as IEEE 802.xxx including NFC, Wi-Fi, Bluetooth, BLE, UWB, and any suitable communication protocol for data exchanging and sharing.

Referring to FIG. 6, a block diagram illustrates an exemplary active control and safety system 500 for an order fulfillment system 504 suitable for an exemplary distribution environment 100 (such as illustrated in FIGS. 1 and 2A). An exemplary order fulfillment system 504 may be as described in commonly assigned U.S. Patent No. 9,604,781, Issued Mar. 28, 2017. A network 520 is communicatively coupled to the active control and safety system 500 wirelessly or wired. The network 520 may also be communicatively coupled to a server 610. The network 520 includes any one or more different types of communications networks such as cable networks, public networks (e.g. Internet), private networks (e.g. frame-relay networks), wireless networks, cellular networks, telephone networks (e.g. public switched telephone network (PSTN)), circuit-switched networks, global networks, metropolitan area networks (MANs), wide area networks (WANs), local area networks (LANs), personal area networks (PANs), wireless local area networks (WLANs), long range wide area networks (LoRaWANs), Long Term Evolution (LTE) networks, WiMAX networks, 3G/4G/5G/6G networks, public cloud networks, private cloud networks, hybrid cloud networks, Industrial Internet of Things (IIOT), distributed networks, decentralized networks, centralized networks, any suitable wireless communication networks, or any communication range associated therewith suitable for an environment.

The active control and safety system 500 includes a processor 506 and a sensing system 508. One or more order fulfillment systems 504 may be coupled to the active control and safety system 500. The order fulfillment system 504 includes a sortation system 102, a conveyor 106, and an automated storage and retrieval system (ASRS) 112, such as illustrated in FIGS. 1 and 2A, as well as a picking station, a workstation station, a buffer station, a palletizer and/or depalletizer station, a packing station, and other systems and equipment for a distribution environment 100. An exemplary sortation system 102 may be configured as described in commonly assigned U.S. Patent No 7,086,519, issued Aug. 8, 2006, which is hereby incorporated herein by reference in its entirety. An exemplary ASRS may be configured as described in commonly assigned U.S. Patent Nos. 8,974,168, issued Mar. 10, 2015, 9,266,675, issued Feb. 23, 2016, and/or 9,630,777, issued Apr. 25, 2017, which are each hereby incorporated herein by reference in their entireties. An exemplary picking station may be configured as described in commonly assigned U.S. Patent App. Ser. No. 16/829,134, filed Mar. 25, 2020, and U.S. Patent Nos. 8,713,899, issued May 6, 2014, 9,604,781, issued Mar. 28, 2017, and/or 10,301,113, issued May 28, 2019, which are each hereby incorporated herein by reference in their entireties. In another example, as illustrated in FIG. 2B, the system 500 may be implemented using agent 150 for active control and safety operations. In yet another embodiment, the system can support multiple agents 150, conveyance and/or material handling systems, and combinations thereof.

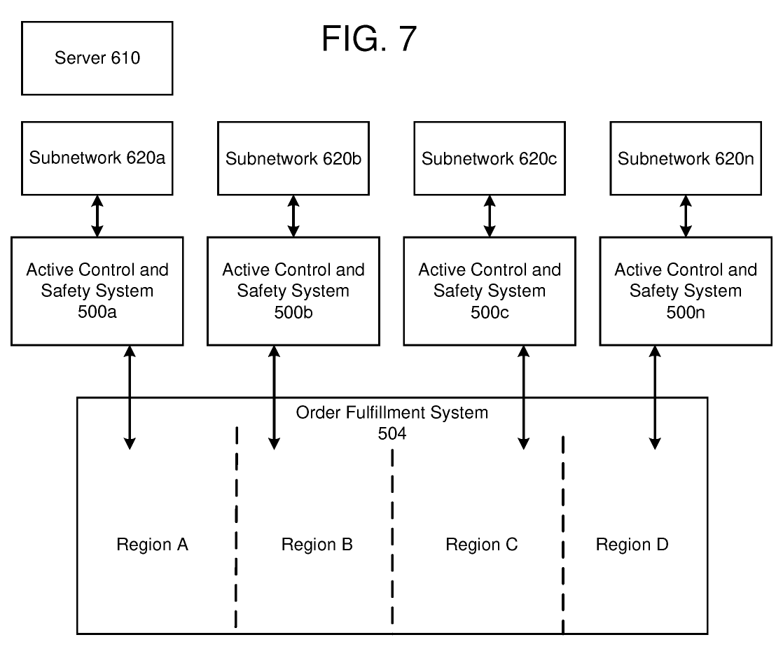

Although only one active control and safety system 500 is illustrated, in other embodiments, such as illustrated in FIG. 7, more than one active control and safety system 500a-n may be installed and operating at the same site (e.g., an order fulfillment system 504 as part of a distribution environment 100, and with each covering different areas (e.g., Regions “A,” “B,” “C,” and “D.”) within the same order fulfillment system 504. One or multiple sub-networks (e.g., subnetworks 620a-n) may be installed and connected to the active control and safety systems 500a-n, which in turn are connected to a server 610. The subnetworks 620a-n, server 610, and the active control and safety systems 500a-n may be communicatively coupled with either a wired or wireless connection. In an alternative embodiment, a plurality of active control and safety systems 500a-n are coupled to respective ones of a plurality of order fulfillment systems 504, with each active control and safety system 500a-n monitoring and managing a separate order fulfillment system 504. While four active control and safety systems (500a, 500b, 500c, and 500n) are illustrated, it is understood that other numbers of active control and safety systems 500 are also anticipated (e.g., two or more). As also discussed herein, the active control and safety system 500 may be implemented as a portable version (e.g., active control and safety system 500’) to be worn or carried by an agent 130 (e.g., a human 140).

With continued reference to FIG. 6, the sensing system 508 includes an agent detector 510, a contour/vector estimator 512, and an access control verifier 514. The agent detector 510 is configured to detect different types of apparel and other attachments worn by an agent 130, 131, such as, a vest, a helmet, a wearable device, a badge/pass/key, a card/fob, or the like. The agent detector 510 (when an agent 130, 131 has been detected) will trigger the contour/vector estimator 512 to calculate and verify one or more values, such as, a motion vector V intersecting with an inner zone 152, an outer zone 154, and/or an order fulfillment system 504, a contour X of a particular body shape information of the agent 130, 131 while entering or leaving the inner zone 152, outer zone 154, or combinations thereof. The contour/vector estimator 512 may be a monolithic module, or two separate modules. The access control verifier 514 is configured to read badge, pass, key card, fob, or any suitable access admission devices associated with the agent 130, 131 to identify a particular agent and to verify whether that agent is an authorized agent 130 or an unauthorized agent 131 (as well as other identification information). In one aspect, the access control verifier 514 may be configured to read fingerprints, scan iris, or recognize facial features to identify the agent (i.e., when the agent is a human 140). In another aspect, the access admission devices may be an application or other software program installed on a portable electronic device, such as, a smart phone, a wearable device (such as a watch), a tablet, and so forth. Upon reception of an authorization input request, the access control verifier 514 may search a database or memory 502 to, for example, validate an authorization and output an access grant to enter the distribution environment 100, to access certain locations within the distribution environment 100, a period of time the access grant remains valid, or combinations thereof. In other words, the access control verifier 514 is configured to determine a particular identity of the requesting agent such that a particular authorization for the agent is request and able to be provided to the requesting agent. Thus, the processor 506 can tailor any processing mode changes to not only the movements of the agent 130, 131 within the order fulfillment system (e.g., within a conveyance system 102, 106, 112), but the particular authorization level and identity of the agent (e.g., for a particular human operator or inspector (e.g., a human 140), or a particular robot 150 (e.g., an AMR or AGV)). The sensing system 508 is then ready to trigger an operational change mode for the order fulfillment system 504 (e.g., for a sortation system 102, a conveyor 106, or an ASRS 112) based upon detected movement vectors V’s and contours X’s associated with the identified agent 130, 131. In a further embodiment, other modules such as a global positioning system (GPS) receiver, an agent’s position locator, and occupancy information, or the like, may be incorporated into or coupled to the system 500. In one example, the sensing system 508 may be integrated as part of a building fixture, such as, lighting, security, floor, door, window, and the like. In another example, the sensing system 508 or individual sensors (e.g., sensor 108) may be mounted on or integrated within one or more order fulfillment systems, such as conveyor systems, ASRS, workstations, and the like (e.g., sensors 108 arranged along conveyor 106). The sensing system 508 may further include an imaging sensor, such as, an RGBD sensor, an ultrasonic sensor, a lidar sensor, a mems optical sensor, and the like, and further incorporating suitable physical artificial intelligence, quantum intelligence, and/or computer vision. Such an imaging sensor may be incorporated into one or more of the agent detector 510, the contour/vector estimator 512, and the access control verifier 514. In one embodiment, the sensor 108 comprises an imaging sensor. A communication module may also be provided, such as an antenna 516 for connecting wirelessly to arrangements and elements (such as systems 500a-500d, sensing system 508, processor 506) and/or portable devices (such as mobile phones, tablets, laptops, etc.), wearable devices (such as vest, eye-wears, watches, etc.), and other suitable electronic devices.

As previously described, a computer system described with reference to the figures herein may generally comprise a processor, an input device coupled to the processor, an output device coupled to the processor, and memory devices each coupled to the processor. The processor may perform computations and control the functions of the system, including executing instructions included in computer code for the tools and programs capable of implementing methods for monitoring warehouses, distribution centers, and intralogistics, in accordance with some embodiments, wherein the instructions of the computer code may be executed by the processor via a memory device. The computer code may include software or program instructions that may implement one or more algorithms for implementing one or more of the foregoing methods. The processor executes the computer code.

The memory device may include input data. The input data includes any inputs required by the computer code. The output device displays output from the computer code. A memory device may be used as a computer usable storage medium (or program storage device) having a computer-readable program embodied therein and/or having other data stored therein, wherein the computer-readable program comprises the computer code. Generally, a computer program product (or, alternatively, an article of manufacture) of the computer system may comprise said computer usable storage medium (or said program storage device).

As will be appreciated by one skilled in the art, the disclosure may be a computer program product. Any of the components of the embodiments of the disclosure can be deployed, managed, serviced, etc. by a service provider that offers to deploy or integrate computing infrastructure with respect to embodiments of the inventive concepts. Thus, an embodiment of the disclosure discloses a process for supporting computer infrastructure, where the process includes providing at least one support service for at least one of integrating, hosting, maintaining and deploying computer-readable code (e.g., program code) in a computer system including one or more processor(s), wherein the processor(s) carry out instructions contained in the computer code causing the computer system for generating a technique described with respect to embodiments. In another embodiment, the disclosure discloses a process for supporting computer infrastructure, where the process includes integrating computer-readable program code into a computer system including a processor.

Aspects of the disclosures are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that numerous various to the above-mentioned approaches are possible. Variations to the above approaches may, for example, include performing the above steps in a different order.

While certain exemplary embodiments have been described and shown in the accompanying drawings, it is to be understood that such embodiments are merely illustrative of are not restrictive on the broad disclosure, and that this disclosure is not limited to the specific constructions and arrangements shown and described, since various other modifications may occur to those of ordinary skill in the art. The description is thus to be regarded as illustrative instead of limited.

Thus, a control system for controlling the operation of a distribution environment in an exemplary facility may include a controller, a sensing system, and a conveyance system. The conveyance system includes a sortation system, a conveyor, and a storage system. A plurality of zones is arranged around the conveyance system. An inner zone of the plurality of zones is adjacent to the conveyance system. An outer zone of the plurality of zones is adjacent to the inner zone and surrounds the inner zone, such that the outer zone must be passed through to reach the inner zone. The controller is configured to receive sensor data from the sensor system, which is configured to monitor the inner zone and the outer zone to detect the presence and movements of agents within the inner zone and the outer zone. The controller is configured to select an operational mode for the conveyance system based upon the sensor data received from the sensor. In one embodiment, the storage system is an automated storage and retrieval system (ASRS). As discussed herein, the agents include human operators or inspectors, robots, such as cobots, humanoids (robots configured with human-like appearance/features), automated guided vehicles (AGVs), and autonomous mobile robots (AMRs), and other human-machine devices, or other devices. The agents are configured to carry out one or more activities in and around the conveyance system of the distribution environment. Each of the agents is identified as either an authorized agent or an unauthorized agent. The controller is configured to identify each agent as a particular authorized or unauthorized agent (with relevant authorizations). The controller is also configured to adjust an operational mode of the conveyance system based upon the identity of a detected agent and the movement of the detected agent. Therefore, based upon the identify and authorization status of the detected agent, the controller is able to control the operational mode of the conveyance system to protect both the agent and materials moving within the conveyance system from harm.

Changes and modifications in the specifically described embodiments can be carried out without departing from the principles of the present invention which is intended to be limited only by the scope of the appended claims, as interpreted according to the principles of patent law including the doctrine of equivalents.

1. A control system for controlling the operation of a distribution environment in a facility comprises:
a conveyance system comprising a sortation system, a conveyor, and a storage system;
a zone arranged around the conveyance system;
a sensor system comprising a sensor arranged with respect to the conveyance system and configured to monitor the zone to detect the presence and movements of agents within the zone;
a controller configured to control the operation of the conveyance system, wherein the controller is further configured to receive sensor data from the sensor system, and wherein the controller is configured to select an operational mode for the conveyance system based upon the sensor data.

2. The control system of claim 1, wherein the zone comprises an inner zone and an outer zone, wherein the inner zone is adjacent to the conveyance system, wherein the outer zone is adjacent to and surrounds the inner zone, such that the outer zone must be passed through to reach the inner zone, and wherein the sensor data comprises information related to the movement of the agents in the inner zone and the outer zone.

3. The control system of claim 1, wherein the agents comprise human operators or inspectors, humanoids, automated guided vehicles (AGVs), autonomous mobile robots (AMRs), robots configured as collaborative or companion robots (cobots), robots configured with an arrangement of wheels for maneuvering, robots configured with a manipulator arm for loading, unloading, and/or picking between a conveyor/shelf and a tote, and/or human-machine devices comprising human-operated devices, and wherein the agents are configured to carry out one or more activities in and around the conveyance system of the distribution environment.

4. The control system of claim 2, wherein the controller is operable to identify particular agents based upon the received sensor data, and wherein the sensor data comprises relevant authorizations for each particular authorized agent.

5. The control system of claim 4, wherein the controller is configured to adjust an operational mode of the conveyance system based upon the identity of a particular detected agent and the movement of that detected agent within the inner zone and/or the outer zone.

6. The control system of claim 5, wherein the controller is configured to control the operational mode of the conveyance system to protect both a detected agent and materials moving within the conveyance system based upon the identity and authorization status of the detected agent as well as the movements of the detected agent within the inner zone and the outer zone.

7. The control system of claim 5, wherein the controller is configured to place the conveyance system into a standby mode when an agent is detected in the inner zone, wherein an increased quantity of computing resources is reserved by the controller for monitoring the agent detected in the inner zone.

8. The control system of claim 5, wherein the controller is configured to change the operational mode of the conveyance system to slow the operations of the conveyance system when either a detected agent in the inner zone is identified as an unauthorized agent, or the detected agent has a movement vector that intercepts an operating surface of the conveyance system.

9. A method of controlling a distribution environment comprising:
providing a conveyance system comprising a sortation system, a conveyor, and a storage system;
arranging a zone around the conveyance system;
arranging a sensor system comprising a sensor with respect to the conveyance system and monitoring the zone to detect the presence and movements of agents within the zone; and
controlling the operation of the conveyance system based on sensor data from the sensor system and selecting an operational mode for the conveyance system based upon the sensor data.

10. The method of claim 9, wherein the zone comprises an inner zone and an outer zone, wherein the inner zone is adjacent to the conveyance system, wherein the outer zone is adjacent to and surrounds inner zone, such that the outer zone must be passed through to reach the inner zone, and wherein the sensor data comprises information related to the movement of the agents in the inner zone and the outer zone.

11. The method of claim 9, wherein the agents comprise human operators or inspectors, humanoids, automated guided vehicles (AGVs), autonomous mobile robots (AMRs), robots configured as collaborative or companion robots (cobots), robots configured with an arrangement of wheels for maneuvering, robots configured with a manipulator arm for loading, unloading, and/or picking between a conveyor/shelf and a tote, and/or other human-machine devices comprising human-operated devices, and wherein the agents are configured to carry out one or more activities in and around the conveyance system of the distribution environment.

12. The method of claim 10 and further comprising identifying particular agents as either authorized agents or unauthorized agents based upon the received sensor data, and wherein the sensor data comprises relevant authorizations for each particular authorized agent.

13. The method of claim 12 and further comprising adjusting an operational mode of the conveyance system based upon the identity of a particular detected agent and the movement of that detected agent within the inner zone and/or the outer zone.

14. The method of claim 13 and further comprising controlling the operational mode of the conveyance system to protect both a detected agent and materials moving within the conveyance system based upon the identity and authorization status of the detected agent as well as the movements of the detected agent within the inner zone and the outer zone.

15. The method of claim 13 and further comprising placing the conveyance system into a standby mode when an agent is detected in the inner zone and reserving an increased quantity of computing resources for monitoring the agent detected in the inner zone.

16. The method of claim 13 and further comprising changing the operational mode of the conveyance system to slow the operations of the conveyance system when either a detected agent in the inner zone is identified as an unauthorized agent, or the detected agent has a movement vector that intercepts an operating surface of the conveyance system.

17. A non-transitory computer-readable medium with instructions stored thereon, that when executed on a processor, perform the steps for controlling the operation of a distribution environment in a facility comprising a conveyance system that comprises a sortation system, a conveyor, and a storage system, and a sensor system comprising a sensor arranged with respect to the conveyance system, wherein the steps comprise:
arranging a zone around the conveyance system;
monitoring, with the sensor system, the zone to detect the presence and movements of agents within the zone;
controlling the operation of the conveyance system based on sensor data from the sensor system; and
selecting an operational mode for the conveyance system based upon the sensor data.

18. The non-transitory computer-readable medium of claim 17, wherein the zone comprises an inner zone and an outer zone, wherein the inner zone is adjacent to the conveyance system, wherein the outer zone is adjacent to and surrounds inner zone, such that the outer zone must be passed through to reach the inner zone, and wherein the sensor data comprises information related to the movement of the agents in the inner zone and the outer zone.

19. The non-transitory computer-readable medium of claim 17, wherein the agents comprise human operators or inspectors, humanoids, automated guided vehicles (AGVs), autonomous mobile robots (AMRs), robots configured as collaborative or companion robots (cobots), robots configured with an arrangement of wheels for maneuvering, robots configured with a manipulator arm for loading, unloading, and/or picking between a conveyor/shelf and a tote, and/or other human-machine devices comprising human-operated devices, and wherein the agents are configured to carry out one or more activities in and around the conveyance system of the distribution environment.

20. The non-transitory computer-readable medium of claim 18 and further comprising identifying particular agents as either authorized agents or unauthorized agents based upon the received sensor data, wherein the sensor data comprises relevant authorizations for each particular authorized agent, and further comprising adjusting an operational mode of the conveyance system based upon the identity of a particular detected agent and the movement of that detected agent within the inner zone and/or the outer zone.

21. The non-transitory computer-readable medium of claim 20 and further comprising controlling the operational mode of the conveyance system to protect both a detected agent and materials moving within the conveyance system based upon the identity and authorization status of the detected agent as well as the movements of the detected agent within the inner zone and the outer zone.

22. The non-transitory computer-readable medium of claim 21 and further comprising placing the conveyance system into a standby mode when an agent is detected in the inner zone and monitoring the agent detected in the inner zone.

23. The non-transitory computer-readable medium of claim 21 and further comprising changing the operational mode of the conveyance system to slow the operations of the conveyance system when either a detected agent in the inner zone is identified as an unauthorized agent, or the detected agent has a movement vector that intercepts an operating surface of the conveyance system.
